(19) United States
(12) Patent Application Publication
(10) Pub. No.: US 2025/0379518 A1
(43) Pub. Date: Dec. 11, 2025

(54) POWER CONVERTER DESIGN FOR ELECTROCALORIC AIR CONDITIONING SYSTEMS

(71) Applicants: Carrier Corporation, Palm Beach Gardens, FL (US); Virginia Tech Intellectual Properties, Inc., Blacksburg, VA (US)

(72) Inventors: Luis Arnedo, South Glastonbury, CT (US); Rolando Burgos, Blacksburg, VA (US); Dong Dong, Schenectady, NY (US); Le Wang, Blacksburg, VA (US)

(21) Appl. No.: 19/232,053

(22) Filed: Jun. 9, 2025

Related U.S. Application Data
(60) Provisional application No. 63/658,173, filed on Jun. 10, 2024.

(51) Int. Cl. H02M 3/07; F25B 21/00; H02M 1/08

(52) U.S. Cl. CPC H02M 3/07; F25B 21/00; H02M 1/08; F25B 2321/001

(57) ABSTRACT

A heat transfer system includes a first electrocaloric module comprising a first electrocaloric material, a first high-side electrode, and a first low-side electrode, arranged to impart an electric field to the electrocaloric material; a second electrocaloric module comprising a second electrocaloric material, a second high-side electrode, and a second low-side electrode, arranged to impart an electric field to the electrocaloric material; a power convertor including a power source configured to supply power to a high side bus and a low side bus; a controller configured to operate the power convertor through a plurality of stages.

### CROSS-REFERENCE TO RELATED APPLICATIONS

This application claims the benefit of U.S. provisional patent application No. 63/658,173 filed Jun. 10, 2024, the entire contents of which are incorporated herein by reference.

### BACKGROUND

The embodiments described herein relate to air conditioning systems. The vapor compression method has been the most prevalent technology used in air conditioning systems since the first air-conditioner was invented. However, there is strong interest for developing environmentally friendly air-conditioning alternatives to vapor compression method. Electrocaloric technology has the advantages of high efficiency, direct electricity-utilization, low cost, and mature processes for mass production.

### SUMMARY

According to an embodiment, a heat transfer system includes a first electrocaloric module comprising a first electrocaloric material, a first high-side electrode, and a first low-side electrode, arranged to impart an electric field to the electrocaloric material; a second electrocaloric module comprising a second electrocaloric material, a second high-side electrode, and a second low-side electrode, arranged to impart an electric field to the electrocaloric material; a power convertor including a power source configured to supply power to a high side bus and a low side bus; a third switch and a fourth switch in series between the high side bus and the low side bus; a precharge resistor and a second inductor in electrical series between the power source and a junction of the third switch and a fourth switch; the first electrocaloric module and the second electrocaloric module in electrical series between the high side bus and the low side bus; a first switch and a second switch in series between the high side bus and the low side bus; a first inductor connected between (i) a junction of the first switch and the second switch and (ii) a junction of the low-side electrode of the first electrocaloric module and the high-side electrode of the second electrocaloric module; a controller configured to operate the first switch, the second switch, the third switch and the fourth switch through a plurality of stages; wherein the first switch, the second switch, the third switch and the fourth switch use silicon carbide MOSFET technology.

In addition to one or more of the features described herein, or as an alternative, further embodiments may include wherein the controller is configured to operate the power convertor in a first period of a first, precharging stage to charge the second electrocaloric module to a voltage of the power source.

In addition to one or more of the features described herein, or as an alternative, further embodiments may include wherein a second period of the first, precharging stage comprises charging the second electrocaloric module to a predetermined voltage.

In addition to one or more of the features described herein, or as an alternative, further embodiments may include wherein the controller is configured to operate the power convertor in a second stage to hold the second electrocaloric module at the predetermined voltage for a period of time.

In addition to one or more of the features described herein, or as an alternative, further embodiments may include wherein the controller is configured to operate the power convertor in a third stage to discharge the second electrocaloric module and charge the first electrocaloric module to the predetermined voltage.

In addition to one or more of the features described herein, or as an alternative, further embodiments may include wherein the controller is configured to operate the power convertor in a fourth stage to hold the first electrocaloric module at the predetermined voltage for a period of time.

In addition to one or more of the features described herein, or as an alternative, further embodiments may include wherein the controller is configured to operate the power convertor in a fifth stage to discharge the first electrocaloric module and charge the second electrocaloric module to the predetermined voltage.

In addition to one or more of the features described herein, or as an alternative, further embodiments may include wherein the controller is configured to repeat the second stage, third stage, fourth stage and fifth stage, in sequence.

In addition to one or more of the features described herein, or as an alternative, further embodiments may include a fifth switch in parallel with the precharge resistor; wherein during the first period of the first, precharging stage the fifth switch is open; and wherein during the second period of the first, precharging stage the fifth switch is closed.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited by the accompanying figures in which like reference numerals indicate similar elements.

FIG. 1 depicts an electrocaloric heat transfer system in an example embodiment.

FIG. 2 depicts a plurality of electrocaloric film segments in a stacked configuration in an example embodiment.

FIG. 3 depicts a power converter configured to control charge between a first electrocaloric module and a second electrocaloric module in an example embodiment.

### DETAILED DESCRIPTION

In order to control the electrocaloric effect, a proper control over the electrical charge and discharge of the material is needed. This objective is accomplished by using a power converter that controls the flow of charge into the electrocaloric material. The functionality can be achieved with multiple topologies, however the circuit of embodiments uses a minimum set of semiconductor switching devices and reduces the size of passive components, such as inductors and capacitors

In order to reduce the size of the passive components, embodiments of the circuit need to operate at high switching frequency and high voltages (e.g., up to 1 kV or more) to increase the electrocaloric effect of the film. Because of the combination of high switching frequency and high voltage, embodiments may use silicon carbide MOSFET technology. Such devices are 2× to 3× more expensive than regular silicon IGBTs, hence any reduction of the number of devices provides a cost advantage.

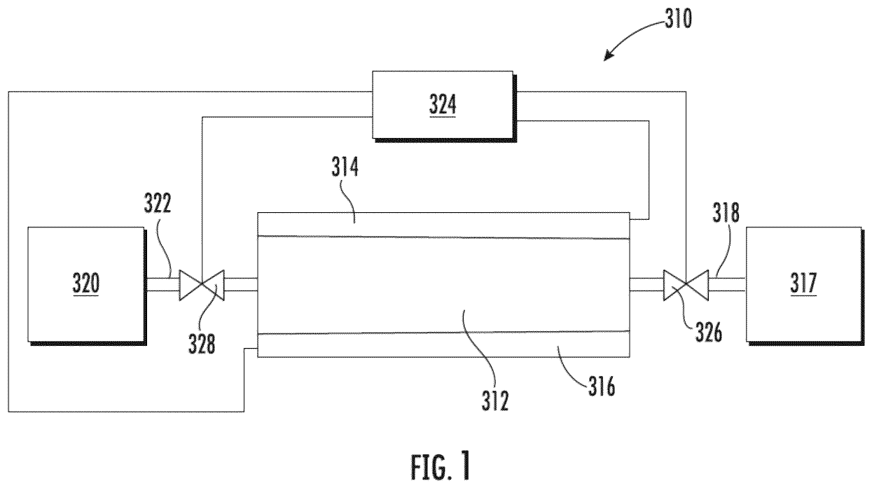

An example embodiment of a heat transfer system and its operation are described with respect to FIG. 1. As shown in FIG. 1, a heat transfer system 310 comprises an electrocaloric material 312 with first and second electrical buses 314 and 316 in electrical communication with electrodes on the electrocaloric material 312. The electrocaloric material 312 is in thermal communication with a heat sink 317 through a first thermal flow path 318, and in thermal communication with a heat source 320 through a second thermal flow path 322. The thermal flow paths can be described with respect thermal transfer through flow of working fluid through control devices 326 and 328 (e.g., flow dampers or valves) between the stack and the heat sink and heat source. A controller 324 (e.g., a microprocessor-based controller) is configured to control electrical current to through a power source (not shown in FIG. 1) to selectively activate the buses 314, 316. In some embodiments, the electrocaloric material 312 can be activated by energizing one bus bar/electrode while maintaining the other bus bar/electrode at a ground voltage. The controller 324 is also configured to open and close control devices 326 and 328 to selectively direct the working fluid along the first and second flow paths 318 and 322.

In operation, the system 310 can be operated by the controller 324 applying an electric field as a voltage differential across the electrocaloric material 312 in the stack to cause a decrease in entropy and a release of heat energy by the electrocaloric material 312. The controller 324 opens the control device 326 to transfer at least a portion of the released heat energy along flow path 318 to heat sink 317. This transfer of heat can occur after the temperature of the electrocaloric material 312 has risen to a threshold temperature. In some embodiments, heat transfer to the heat sink 317 is begun as soon as the temperature of the electrocaloric material 312 increases to be about equal to the temperature of the heat sink 317. After application of the electric field for a time to induce a desired release and transfer of heat energy from the electrocaloric material 312 to the heat sink 317, the electric field can be removed. Removal of the electric field causes an increase in entropy and a decrease in heat energy of the electrocaloric material 312. This decrease in heat energy manifests as a reduction in temperature of the electrocaloric material 312 to a temperature below that of the heat source 320. The controller 324 closes control device 326 to terminate flow along flow path 318 and opens control device 328 to transfer heat energy from the heat source 320 to the colder electrocaloric material 312 in order to regenerate the electrocaloric material 312 for another cycle.

In some embodiments, for example where a heat transfer system is utilized to maintain a temperature in a conditioned space or thermal target, the electric field can be applied to the electrocaloric material 312 to increase temperature until the temperature reaches a first threshold. After the first temperature threshold, the controller 324 opens control device 326 to transfer heat from the stack to the heat sink 317 until a second temperature threshold is reached. The electric field can continue to be applied during all or a portion of the time period between the first and second temperature thresholds, and is then removed to reduce the temperature until a third temperature threshold is reached. The controller 324 then closes control device 326 to terminate heat flow transfer along heat flow path 318, and opens control device 328 to transfer heat from the heat source 320 to the stack. The above steps can be optionally repeated until a target temperature of the conditioned space or thermal target (which can be either the heat source or the heat sink) is reached.

In some embodiments, the electrocaloric material 312 referenced above can comprise an electrocaloric film connected to a frame. The frame can include various configurations, including but not limited to full peripheral frames (e.g., ‘picture’ frames) and components thereof, partial peripheral frames and components thereof, or internal frames and components thereof. In some embodiments, the frame can be part of a repeating modular structure that can be assembled along with a set of electrocaloric films in a stack-like fashion. In some embodiments, the frame can be a unitary structure equipped with one or more attachment points to receive one or more of electrocaloric films.

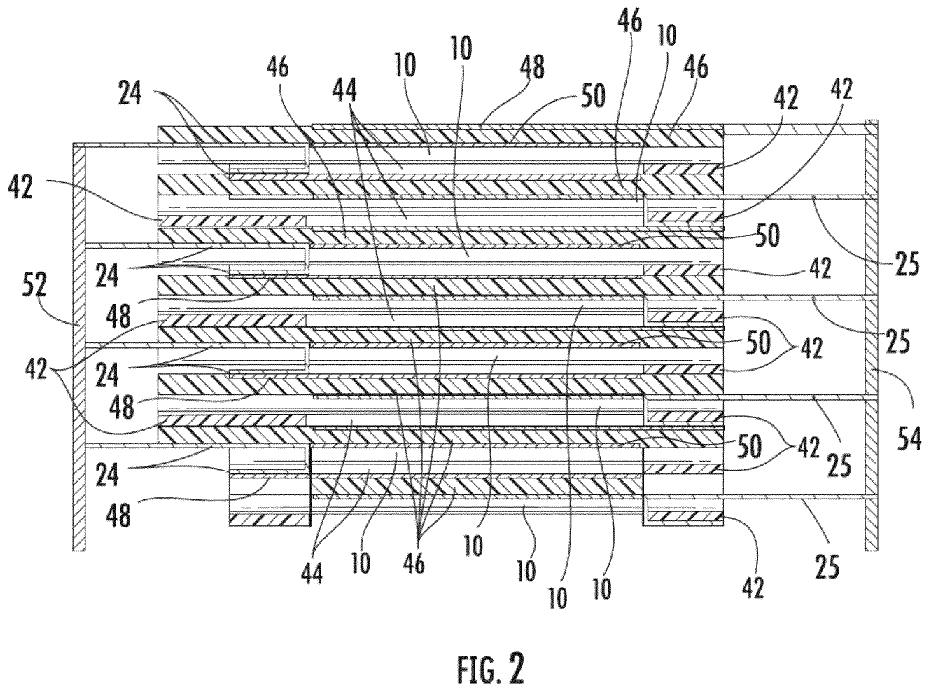

In some embodiments, a heat transfer device can include a plurality of electrocaloric film segments in a stack configuration arranged to provide flow paths for a working fluid between adjacent electrocaloric film segments. A stack of repeating modular framed electrocaloric films 46 is schematically shown in a cross-sectional view in FIG. 2. The order of assembly can be varied and adapted to achieve target specifications, and the order shown in FIG. 2 is a typical example including peripheral frames 10, spacers 42, electrocaloric elements having electrocaloric films 46 with first electrodes 48 and second electrodes 50, and first and second electrically conductive elements 24, 25 electrically connected to the first and second electrodes 48, 50 and to first and second electrical buses 52, 54, respectively. As shown in FIG. 2, the electrocaloric films are disposed in the stack with a configuration such that the relative (top/bottom) orientation of the first and second electrodes 48, 50 is alternated with adjacent films so that each fluid flow path 44 has electrodes of matching polarity on each side of the fluid flow path 44, which can inhibit arcing across the flow path gap.

It should be noted that although FIG. 2 discloses individual segments of electrocaloric film attached to a peripheral frame in a picture-frame configuration, other configurations of electrocaloric articles can be utilized such as electrocaloric articles formed from a continuous sheet of electrocaloric film, or different frame configurations such as internal frame components (e.g., stack spacers) or peripheral frames covering less than the full perimeter of the electrocaloric film, or combinations of the above features with each other or other features. Continuous sheets of electrocaloric film can be dispensed directly from a roll and manipulated by bending back and forth into a stack-like configuration, or can be cut into a pre-cut length and bent back and forth into the stack-like configuration. Additional disclosure regarding continuous sheet electrocaloric articles can be found in PCT published application no. WO2017/111916 A1, and in PCT published application no. WO2020/041738 A1, the disclosures of both of which are incorporated herein by reference in their entirety. Also, the stack of FIG. 2 or other electrocaloric heat transfer devices can be arranged in a cascade with other electrocaloric heat transfer devices such as disclosed in US Patent Pub. No. 2017/0356679 A1, the disclosure of which is incorporated herein by reference in its entirety.

As mentioned above, the electrocaloric module includes an electrocaloric material, such as an electrocaloric film that can be formed into a stack-like structure. Examples of electrocaloric materials for the electrocaloric film can include but are not limited to inorganic (e.g., ceramics) or organic materials such as electrocaloric polymers, and polymer/ceramic composites. Composite materials such as organic polymers with inorganic fillers and/or fillers of a different organic polymer. Examples of inorganic electrocaloric materials include but are not limited to PbTiO3 (“PT”), Pb(Mg1/3Nb2/3)O3 (“PMN”), PMN-PT, LiTaO3, barium strontium titanate (BST) or PZT (lead, zirconium, titanium, oxygen). Examples of electrocaloric polymers include, but are not limited to ferroelectric polymers, liquid crystal polymers, and liquid crystal elastomers. Ferroelectric polymers are crystalline polymers, or polymers with a high degree of crystallinity, where the crystalline alignment of polymer chains into lamellae and/or spherulite structures can be modified by application of an electric field. Such characteristics can be provided by polar structures integrated into the polymer backbone or appended to the polymer backbone with a fixed orientation to the backbone. Examples of ferroelectric polymers include polyvinylidene fluoride (PVDF), polytriethylene fluoride, odd-numbered nylon, copolymers containing repeat units derived from vinylidene fluoride, and copolymers containing repeat units derived from triethylene fluoride. Polyvinylidene fluoride and copolymers containing repeat units derived from vinylidene fluoride have been widely studied for their ferroelectric and electrocaloric properties. Examples of vinylidene fluoride-containing copolymers include copolymers with methyl methacrylate, and copolymers with one or more halogenated co-monomers including but not limited to trifluoroethylene, tetrafluoroethylene, chlorotrifluoroethylene, trichloroethylene, vinylidene chloride, vinyl chloride, and other halogenated unsaturated monomers. In some embodiments, the electrocaloric film can include a polymer composition according to WO 2018/004518 A1 or WO 2018/004520 A1, the disclosures of which are incorporated herein by reference in their entirety.

Liquid crystal polymers, or polymer liquid crystals comprise polymer molecules that include mesogenic groups. Mesogenic molecular structures are well-known, and are often described as rod-like or disk-like molecular structures having electron density orientations that produce a dipole moment in response to an external field such as an external electric field. Liquid crystal polymers typically comprise numerous mesogenic groups connected by non-mesogenic molecular structures. The non-mesogenic connecting structures and their connection, placement and spacing in the polymer molecule along with mesogenic structures are important in providing the fluid deformable response to the external field. Typically, the connecting structures provide stiffness low enough so that molecular realignment is induced by application of the external field, and high enough to provide the characteristics of a polymer when the external field is not applied. In some exemplary embodiments, a liquid crystal polymer can have rod-like mesogenic structures in the polymer backbone separated by non-mesogenic spacer groups having flexibility to allow for re-ordering of the mesogenic groups in response to an external field. Such polymers are also known as main-chain liquid crystal polymers. In some exemplary embodiments, a liquid crystal polymer can have rod-like mesogenic structures attached as side groups attached to the polymer backbone. Such polymers are also known as side-chain liquid crystal polymers. Electrodes on the electrocaloric film can take different forms with various electrically conductive components. The electrodes can be any type of conductive material, including but not limited to metallized layers of a conductive metal such as aluminum or copper, or other conductive materials such as carbon (e.g., carbon nanotubes, graphene, or other conductive carbon). Noble metals can also be used, but are not required. Other conductive materials such as a doped semiconductor, ceramic, or polymer, or conductive polymers can also be used. In some embodiments, the electrodes can be in the form of metalized layers or patterns on each side of the film such as disclosed in published PCT application WO 2017/111921 A1, the disclosure of which is incorporated herein by reference in its entirety.

In some embodiments, electrocaloric film thickness can be in a range having a lower limit of 0.1 μm, more specifically 0.5 μm, and even more specifically 1 μm. In some embodiments, the film thickness range can have an upper limit of 1000 μm, more specifically 100 μm, and even more specifically 10 μm. It is understood that these upper and lower range limits can be independently combined to disclose a number of different possible ranges. Within the above general ranges, it has been discovered that thinner films can promote efficiency by reducing parasitic thermal losses, compared to thicker films.

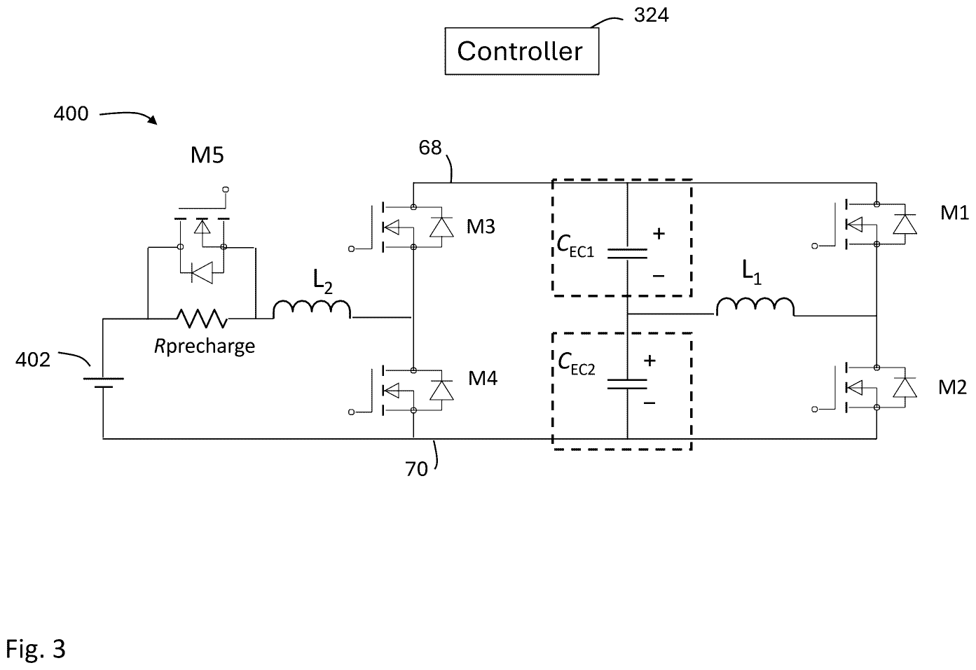

FIG. 3 depicts a power converter 400 configured to control charge between a first electrocaloric module C_{EC1} and a second electrocaloric module C_{EC2} in an example embodiment. In the power converter 400, a first switch M₁ and a second switch M₂ and a first inductor L₁ are connected as a bidirectional buck-boost converter. The first inductor L₁ is employed as a medium to transfer charge between the first electrocaloric module C_{EC1} and the second electrocaloric module C_{EC2}. A third switch M₃ and a fourth switch M₄ and a second inductor L₂ are connected as a boost converter to provide an initial charge as well as to compensate for losses during operation for the system. A fifth switch M₅ and a resistor R_{precharge} are used to limit the inrush current of the boost converter. A power source 402 is represented as a DC source and may be implemented using a rectified and filtered AC voltage.

The first electrocaloric module C_{EC1} and the second electrocaloric module C_{EC2} (e.g., a thin-film stack-like configuration of thin electrocaloric films with electrodes and fluid flow path(s) in thermal and fluid communication with the films such as shown in FIGS. 1 and 2) are connected to the power converter 400. The first electrocaloric module C_{EC1} includes a first electrocaloric material, a first high-side electrode, and a first low-side electrode, arranged to impart an electric field to the first electrocaloric material, and the second electrocaloric module C_{EC2} includes a second electrocaloric material, a second high-side electrode, and a second low-side electrode, arranged to impart an electric field to the second electrocaloric material. The first and second electrocaloric materials can be the same as each other or different, and the other components (e.g., electrodes) can the same or different between the first and second modules. In some embodiments, the electrocaloric modules are identical or matched to provide equivalent performance to facilitate out of phase synchronized operation in connection with a single heat source and heat sink.

An electric power source 402 provides a voltage difference between a high-side voltage (e.g., a positive voltage) at high side bus 68 and a low-side voltage (e.g., a negative or neutral voltage) at low side bus 70. The resistor R_{precharge} is connected to a positive terminal of the power source 402. The second inductor L₂ has a first terminal connected to the resistor R_{precharge} and a second terminal connected to a junction of the source terminal of third switch M₃ and the drain terminal of the fourth switch M₄. The fifth switch M₅ is connected in parallel across the resistor R_{precharge} and may be used to short the resistor R_{precharge}.

The third switch M₃ has a drain terminal connected to the high side bus 68. The source terminal of the third switch M₃ is connected to the drain terminal of the fourth switch M₄. The source terminal of the fourth switch M₄ is connected to the low side bus 70. The third switch M₃ and the fourth switch M₄ are connected in series between the high side bus 68 and the low side bus 70.

The high-side electrode of first electrocaloric module C_{EC1} is connected to the high side bus 68. The low-side electrode of first electrocaloric module C_{EC1} is connected high-side electrode of second electrocaloric module C_{EC2}. The low-side electrode second electrocaloric module C_{EC2} is connected to the low side bus 70. The first electrocaloric module C_{EC1} and the second electrocaloric module C_{EC2} are connected in series between the high side bus 68 and the low side bus 70. The first electrocaloric module C_{EC1} and the second electrocaloric module C_{EC2} are in electrical parallel with the third switch M₃ and the fourth switch M₄.

The first switch M₁ has a drain terminal connected to the high side bus 68. The source terminal of the first switch M₁ is connected to the drain terminal of the second switch M₂. The source terminal of the second switch M₂ is connected to the low side bus 70. The first switch M₁ and the second switch M₂ are connected in electrical series between the high side bus 68 and the low side bus 70. The first electrocaloric module C_{EC1} and the second electrocaloric module C_{EC2} are in electrical parallel with the first switch M₁ and the second switch M₂.

The first inductor L₁ is connected between (i) the junction of the low-side electrode of first electrocaloric module C_{EC1} and the high-side electrode of second electrocaloric module C_{EC2} and (ii) the junction of the source terminal of the first switch M₁ is connected to the drain terminal of the second switch M₂.

The controller 324 controls the switches M₁, M₂, M₃, M₄ and M₅ to transfer charge between the first electrocaloric module C_{EC1} and the high-side electrode of second electrocaloric module C_{EC2}. The controller 324 applies control signals to the gate terminals of the switches M₁, M₂, M₃, M₄ and M₅ to achieve the desired charge transfer.

The operation of the power converter 400 can be divided into the following stages.

In a first, precharging stage, the second electrocaloric module C_{EC2} is initially precharged to the voltage of the power source 402 and subsequently charged to a predetermined voltage (e.g., 1 kV).

There are two periods in the first, precharging stage. In the first period, the fourth switch M₄ and the fifth switch M₅ are turned off while the third switch M₃ is turned on. The power source 402 charges, for example, the second electrocaloric module C_{EC2} through the resistor R_{precharge}, the second inductor L₂ and the third switch M₃. Since the two electrocaloric modules C_{EC1} and C_{EC2} are operated out of phase, which means only one of them should be charged during this stage, the first switch M₁ and the second switch M₂ are switching so that the charge in the first electrocaloric module C_{EC1}, for example, is transferred to the second electrocaloric module C_{EC2} to make sure only the second electrocaloric module C_{EC2} is charged up while the voltage across the first electrocaloric module C_{EC1} is maintained near zero. To transfer charge from the first electrocaloric module C_{EC1} to the second electrocaloric module C_{EC2}, the first switch M₁ is turned on when the voltage across the first electrocaloric module C_{EC1}, V_{EC1}, is larger than zero, so that the first inductor L₁ is charged. Once the current of the first inductor L₁, I_{L1}, reaches the desired maximum value, 10 A for example, or V_{EC1} is less than zero, the first switch M₁ is turned off and the second switch M₂ is turned on after a deadtime so that the energy stored in the first inductor L₁ is transferred into the second electrocaloric module C_{EC2}. Once I_{L1} decreases to zero, one period of charge transfer ends and the next period will start once V_{EC1} is larger than zero again.

Once the sum of the voltages of the electrocaloric modules V_{EC1}+V_{EC2} reaches the voltage of the power source 402, the system enters the second period of the first, precharging stage. The fifth switch M₅ is turned on and the resistor R_{precharge} is bypassed to reduce the unnecessary conduction loss. During this second period, the power source 402 continues to provide initial charge to the second electrocaloric module C_{EC2} through the boost converter including the third switch M₃, the fourth switch M₄, and the send inductor L₂. For each period, the fourth switch M₄ is turned on and the third switch M₃ is turned off first so that the current of second inductor L₂, I_{L2}, is charged up to a desired value. After that, the fourth switch M₄ is turned off and the third switch M₃ is turned on so that the energy stored in the second inductor L₂ is released to the second electrocaloric module C_{EC2}. Once I_{L2} decreases back to zero, the third switch M₃ is turned off and the fourth switch M₄ is turned on again to start the next period. During this period, the first switch M₁, the second switch M₂, and the first inductor L₁ are operated in the same way as that in the first period to make sure only one of the electrocaloric modules C_{EC1} and C_{EC2} is charged up. The second period of the first, precharging stage ends when the voltage across the second electrocaloric module C_{EC2} reaches desired value, 1 kV for example for this work.

At a second stage, voltage V_{EC2} across the second electrocaloric module C_{EC2} is held at the predetermined voltage for a period of time (e.g., tens of seconds) to wait for the heat transfer between the second electrocaloric module C_{EC2} and a regenerator. The power source 402 provides the power needed in this stage to the second electrocaloric module C_{EC2} through the front-end boost converter, including the second inductor L₂, the third switch M₃ and the fourth switch M₄. The first switch M₁ and the second switch M₂ are controlled to transfer any charge in the first electrocaloric module C_{EC1} to the second electrocaloric module C_{EC2} to keep a voltage V_{EC1} across the first electrocaloric module C_{EC1} at zero volts. The time length of this stage is programmable via the controller 324.

At a third stage, a voltage V_{EC2} across the second electrocaloric module C_{EC2} is discharged from the predetermined voltage to 0 volts and the charge is transferred to the first electrocaloric module C_{EC1}. The front-end boost converter is operated at discontinuous conduction mode to compensate the loss during this stage so that at the end of this stage a voltage V_{EC1} across the first electrocaloric module C_{EC1} is charged from 0 to the predetermined voltage.

At a fourth stage, a voltage V_{EC1} across the first electrocaloric module C_{EC1} is held at the predetermined voltage for a period of time (e.g., tens of seconds) to wait for the heat transfer between the first electrocaloric module C_{EC1} and the regenerator. The power source 402 provides the power needed in this stage to the first electrocaloric module C_{EC1} through the front-end boost converter. The first switch M₁ and the second switch M₂ are controlled to transfer any charge in the second electrocaloric module C_{EC2} to the first electrocaloric module C_{EC1} to keep a voltage V_{EC2} across the second electrocaloric module C_{EC2} at zero volts. The time length of this stage is programmable via the controller 324.

At a fifth stage, voltage V_{EC1} across the first electrocaloric module C_{EC1} is discharged from the predetermined voltage to 0 volts and the charge is transferred to the second electrocaloric module C_{EC2}. The front-end boost converter is operated at discontinuous conduction mode to compensate the loss during this stage so that at the end of this stage voltage V_{EC2} across the second electrocaloric module C_{EC2} is charged from 0 to the predetermined voltage.

The power converter 400 will repeat second through fifth stages, without the first precharging stage, as needed. The fifth switch M₅ is turned on and the resistor R_{precharge} is bypassed during the second through fifth stages.

In order to reduce the size of the passive components (e.g., inductors L₁ and L₂) the proposed circuit needs to operate at high switching frequency and high voltages (up to 1 kV or more) to increase the electrocaloric effect of the electrocaloric modules. Due to the combination of high switching frequency and high voltage, embodiments use silicon carbide MOSFET technology for switches M₁-M₅. These devices are more expensive that silicon IGBT devices, hence any reduction of the number of devices provides a cost advantage. Embodiments use a minimum set of semiconductor switching devices M₁-M₅, thereby and reducing the size of passive components such as inductor and capacitors.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification and/or the claims, specify the presence of stated features, steps, operations, elements, and/or components, but do not preclude the presence or addition of one or more other features, steps, operations, elements, components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A heat transfer system, comprising:
a first electrocaloric module comprising a first electrocaloric material, a first high-side electrode, and a first low-side electrode, arranged to impart an electric field to the electrocaloric material;
a second electrocaloric module comprising a second electrocaloric material, a second high-side electrode, and a second low-side electrode, arranged to impart an electric field to the electrocaloric material;
a power convertor comprising:
a power source configured to supply power to a high side bus and a low side bus;
a third switch and a fourth switch in series between the high side bus and the low side bus;
a precharge resistor and a second inductor in electrical series between the power source and a junction of the third switch and a fourth switch;
the first electrocaloric module and the second electrocaloric module in electrical series between the high side bus and the low side bus;
a first switch and a second switch in series between the high side bus and the low side bus;
a first inductor connected between (i) a junction of the first switch and the second switch and (ii) a junction of the low-side electrode of the first electrocaloric module and the high-side electrode of the second electrocaloric module;
a controller configured to operate the first switch, the second switch, the third switch and the fourth switch through a plurality of stages;
wherein the first switch, the second switch, the third switch and the fourth switch use silicon carbide MOSFET technology.

2. The heat transfer system of claim 1, wherein the controller is configured to operate the power convertor in a first period of a first, precharging stage to charge the second electrocaloric module to a voltage of the power source.

3. The heat transfer system of claim 2, wherein a second period of the first, precharging stage comprises charging the second electrocaloric module to a predetermined voltage.

4. The heat transfer system of claim 3, wherein the controller is configured to operate the power convertor in a second stage to hold the second electrocaloric module at the predetermined voltage for a period of time.

5. The heat transfer system of claim 4, wherein the controller is configured to operate the power convertor in a third stage to discharge the second electrocaloric module and charge the first electrocaloric module to the predetermined voltage.

6. The heat transfer system of claim 5, wherein the controller is configured to operate the power convertor in a fourth stage to hold the first electrocaloric module at the predetermined voltage for a period of time.

7. The heat transfer system of claim 6, wherein the controller is configured to operate the power convertor in a fifth stage to discharge the first electrocaloric module and charge the second electrocaloric module to the predetermined voltage.

8. The heat transfer system of claim 7, wherein the controller is configured to repeat the second stage, third stage, fourth stage and fifth stage, in sequence.

9. The heat transfer system of claim 3, further comprising a fifth switch in parallel with the precharge resistor;
wherein during the first period of the first, precharging stage the fifth switch is open; and
wherein during the second period of the first, precharging stage the fifth switch is closed.
